(19) United States
(12) Patent Application Publication
(10) Pub. No.: US 2010/0321707 A1
(43) Pub. Date: Dec. 23, 2010

(54) IMAGE FORMING APPARATUS, METHOD OF CONTROLLING THE SAME, AND STORAGE MEDIUM

(75) Inventor: Kazuhiro Koga, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/782,729

(22) Filed: May 19, 2010

(30) Foreign Application Priority Data
Jun. 17, 2009 (JP) 2009-144643

(51) Int. Cl. G06F 15/00

(52) U.S. Cl. 358/1.5

(57) ABSTRACT

Parameters of image processing to be executed on image data to be formed on a sheet are set. When conveying a plurality of sheets on each of which an image is to be formed, the plurality of sheets are conveyed at a first interval or a second interval shorter than the first interval, and an image based on the image data processed based on the set parameters by an image processing unit is formed on each conveyed sheet. Control is performed such that the parameters are set when forming an image by conveying the plurality of sheets at the first interval, and a part of the parameters is set when forming an image by conveying the plurality of sheets at the second interval.

### BACKGROUND OF THE INVENTION

1. Field of the Invention

The present invention relates to an image forming apparatus, a method of controlling the same, and a storage medium.

2. Description of the Related Art

Conventionally, an image forming apparatus sets parameters (for example, a density value) for image processing that is to be executed on image data to be formed on a sheet, processes the image data based on the set parameters, and forms an image on the sheet based on the processed image data.

Japanese Patent Laid-Open No. 2002-347987 has disclosed an image forming apparatus that performs image formation (printing) by shortening the interval between sheets to be conveyed in succession, in order to rapidly print images on sheets and rapidly discharge the printed sheets.

This prior art decreases the sheet interval based on the assumption that image processing executed on image data to be formed is complete between sheets. When further shortening the sheet interval in an image forming apparatus, however, image processing to be executed on image data to be formed on the successive sheet and the setting of each parameter to be executed before the image processing cannot be executed in time. This makes it impossible to further shorten the sheet interval and execute efficient image formation.

### SUMMARY OF THE INVENTION

An aspect of the present invention is to eliminate the above-mentioned problems with the conventional technology.

A feature of the present invention is to provide a technique which, when shortening the interval between sheets, forms an image by conveying sheets at a short internal by executing image processing by setting some of parameters.

According to an aspect of the present invention, there is provided an image forming apparatus comprising:

a setting unit configured to set parameters of image processing to be executed on image data;

an image processing unit configured to process the image data in accordance with the parameters of the image processing set by the setting unit;

a conveyance control unit configured to convey, when conveying a plurality of sheets on each of which an image is to be formed, the plurality of sheets at one of a first interval and a second interval shorter than the first interval;

an image forming unit configured to form an image on a sheet conveyed by the conveyance control unit, based on the image data processed by the image processing unit; and

a control unit configured to (i) control the setting unit to set the parameters, when conveying the plurality of sheets at the first interval by the conveyance control unit and forming an image by the image forming unit, and (ii) control the setting unit not to set a part of the parameters, when conveying the plurality of sheets at the second interval by the conveyance control unit and forming an image by the image forming unit.

According to another aspect of the present invention, there is provided a control method of an image forming apparatus, comprising:

a setting step of setting parameters of image processing to be executed on image data;

an image processing step of processing the image data in accordance with the parameters of the image processing set in the setting step;

a conveyance control step of conveying, when conveying a plurality of sheets on each of which an image is to be formed, the plurality of sheets at one of a first interval and a second interval shorter than the first interval;

an image forming step of forming an image on a sheet conveyed in the conveyance control step, based on the image data processed in the image processing step; and

a control step of controlling the setting step to set the parameters when conveying the plurality of sheets at the first interval in the conveyance control step and forming an image in the image forming step, and

controlling the setting step to set a part of the parameters when conveying the plurality of sheets at the second interval in the conveyance control step and forming an image in the image forming step.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of an image forming apparatus (printer) according to an embodiment;

FIG. 2 depicts a sectional view illustrating an example of the mechanism of the image forming apparatus according to the embodiment;

FIG. 3 is a block diagram showing the functional configuration of a control unit of the image forming apparatus according to the embodiment;

FIG. 4 is a flowchart describing the procedure of copying performed by the image forming apparatus according to the embodiment;

FIG. 5 depicts an external view illustrating an example of a console unit of the image forming apparatus according to the embodiment;

FIG. 6 is a block diagram illustrating the arrangement of a scanner image signal processing unit according to the embodiment;

FIG. 7 is a block diagram showing the arrangement of a printer image processing unit according to the embodiment;

FIG. 8 is a block diagram showing the arrangement of a drawing processing unit according to the embodiment;

FIG. 9 depicts a view illustrating an example of a window displayed on a UI display section while the image forming apparatus is performing printing;

FIG. 10 depicts a view illustrating an example of the window on the UI display section when setting power saving in the image forming apparatus;

FIG. 11 depicts a view illustrating the register map of registers for holding setting information of each image processor of the printer image processing unit;

FIG. 12 is a flowchart describing the process of setting various data in the registers of the printer image processing unit;

FIG. 13 is a timing chart when setting data in all the registers of the printer image processing unit between pages in the image forming apparatus in response to a user's density adjusting operation;

FIG. 14 is a timing chart when omitting the density change setting of the printer image processing unit when printing only one copy;

FIG. 15 is a timing chart when omitting the density change setting of the printer image processing unit when printing a plurality of copies;

FIG. 16 depicts a view illustrating an example of a warning window when a density changing operation is performed during the process of printing one copy; and

FIG. 17 depicts a view illustrating an example of the warning window when the density changing operation is performed during the process of printing a plurality of copies.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required to solve the problems according to the present invention.

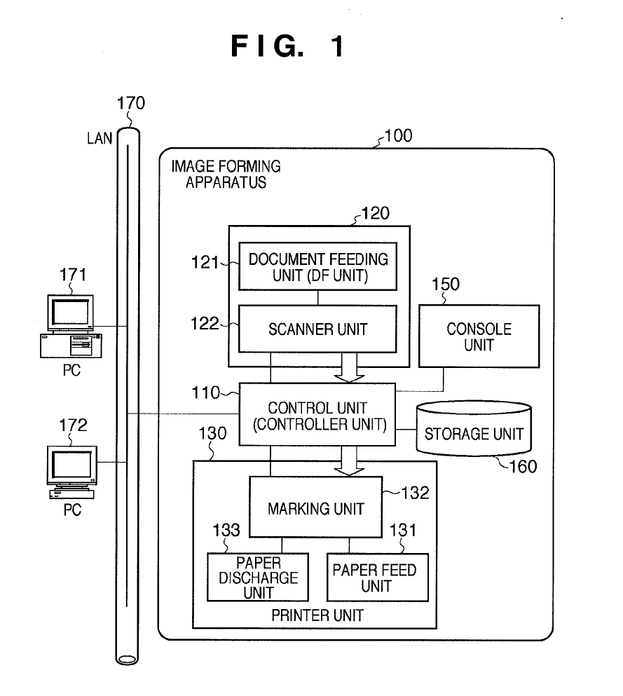

FIG. 1 is a block diagram illustrating the arrangement of an image forming apparatus (printer) according to an embodiment of the present invention.

An image forming apparatus 100 is connected to host computers (in this embodiment, PCs 171 and 172) across a LAN 170 such as the Ethernet.

The image forming apparatus 100 includes a reader unit 120 used to read an original and obtain image data of the original, and a printer unit 130 for performing printing by an electrophotographic method based on the image data. The image forming apparatus 100 further includes a console unit 150 including a keyboard for designating input/output operations, and a liquid crystal panel for displaying and setting various functions. In addition, the image forming apparatus 100 includes a storage unit 160 for storing image data obtained by the reader unit 120, and image data generated from code data received from the PC 171 or 172 across the LAN 170. The image forming apparatus 100 also includes a control unit 110 connected to these constituent components to control them.

The reader unit 120 includes an original document feed unit 121 for feeding originals, and a scanner unit 122 for optically reading an original and converting it into image data as an electrical signal. The printer unit 130 includes a paper feed unit 131, marking unit 132, and paper discharge unit 133. The paper feed unit 131 includes a plurality of paper feed cassettes for accommodating sheets. The marking unit 132 has a mechanism for transferring image data onto a sheet, and fixing the data to the sheet. The paper discharge unit 133 has a mechanism for sorting and/or stapling printed sheets, and discharging the sheets outside the image forming apparatus 100.

The control unit 110 provides a copy function to load image data of an original by controlling the reader unit 120, and printing the image data on a sheet by controlling the printer unit 130. The control unit 110 also has a scanner function to convert image data read by the reader unit 120 into code data, and transmit the code data to the PC 171 or 172 across the network 170. Furthermore, the control unit 110 has a printer function of converting code data received from the PC across the network 170 into image data, and printing the image data by the printer unit 130, and other functional blocks.

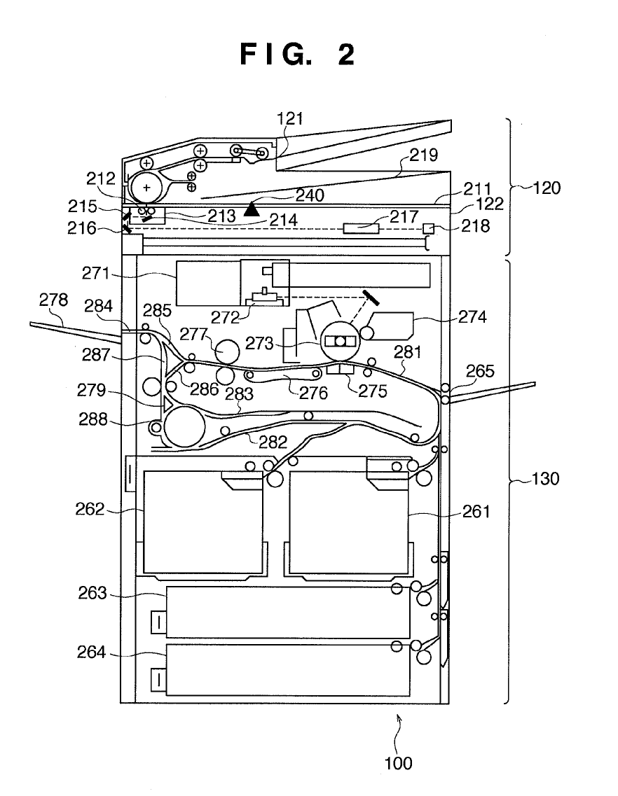

FIG. 2 depicts a sectional view illustrating an example of the mechanism of the image forming apparatus 100 according to the embodiment.

In the reader unit 120, originals stacked in the original document feed unit 121 are sequentially fed one by one from the top one of the stack onto a platen glass 211. After the scanner unit 122 completes a predetermined reading operation, the read originals are discharged to a paper discharge tray 219. Also, when an original is conveyed to the platen glass 211, a lamp 212 is turned on, and an optical unit 213 starts moving in the horizontal direction of FIG. 2 (a sub scan direction) to irradiate the original from below, thereby scanning the original in a main scan direction. The light reflected from the original by this scanning is guided to a CCD image sensor (to be referred to as a CCD hereinafter) 218 via mirrors 214, 215, and 216 and a lens 217, and the CCD 218 generates image data corresponding to the original image. The image data generated by the CCD 218 undergoes predetermined processing, and is transferred to the control unit 110.

Note that when the original document feed unit 121 has a flowing document reading function, stacked originals respectively pass through a flowing document reading position 240 at a predetermined speed. In this case, the optical unit 213 moves to and stops in the flowing document reading position 240, irradiates each original conveyed at a constant velocity with the lamp 212, and sequentially reads images of main scan lines by the CCD 218, thereby generating image data of the original. The optical unit 213 transfers the image data to the control unit 110.

In the printer unit 130, a laser emitting unit 272 driven by a laser driver 271 emits laser light that corresponds to the image data supplied from the control unit 110. Consequently, an electrostatic latent image that corresponds to the laser light is formed on a photosensitive drum 273. A developing agent (toner) supplied from a developer 274 adheres to this electrostatic latent image, thereby forming a toner image corresponding to the image data.

On the other hand, at a timing synchronized with the start of laser light irradiation, a sheet is fed from one of cassettes 261, 262, 263, and 264 or a manual feed tray 265. The fed sheet is conveyed to a transfer unit 275 through a conveyance path 281, and the toner image on the photosensitive drum 273 is transferred onto this sheet. A conveyance belt 276 conveys the sheet having the transferred toner image to a fixing unit 277 where the toner image is fixed on the sheet by heating and pressing. More specifically, the fixing unit 277 includes a heater, and the control unit 110 warms the heater by supplying electric power to it. The toner is melted by heating by this heater, and the toner image is fixed to the sheet by pressing. Also, the control unit 110 controls whether to supply electric power to the heater of the fixing unit 277 by turning on or off a switch (not shown). The sheet to which the toner image is fixed in the fixing unit 277 is discharged to a discharge bin 278 through conveyance paths 285 and 284. When turning over the sheet before discharging it to the discharge bin 278, the fixed sheet is guided to conveyance paths 286 and 288, conveyed in the opposite direction, and discharged to the discharge bin 278 through a conveyance path 287 and the conveyance path 284. Note that although not shown, a paper discharge unit may also be attached instead of the discharge bin 278. This paper discharge unit is capable of, for example, sorting discharged sheets by bundling them, and stapling the sorted sheets.

When printing images on the both sides of the sheet, the sheet having passed through the fixing unit 277 is guided from the conveyance path 286 to a conveyance path 283 by a flapper 279, conveyed in the opposite direction, and guided to the conveyance path 288 and a paper re-feed conveyance path 282 by the flapper 279. The sheet thus guided to the paper re-feed conveyance path 282 is conveyed to the transfer unit 275 through the conveyance path 281 in the same manner as described above.

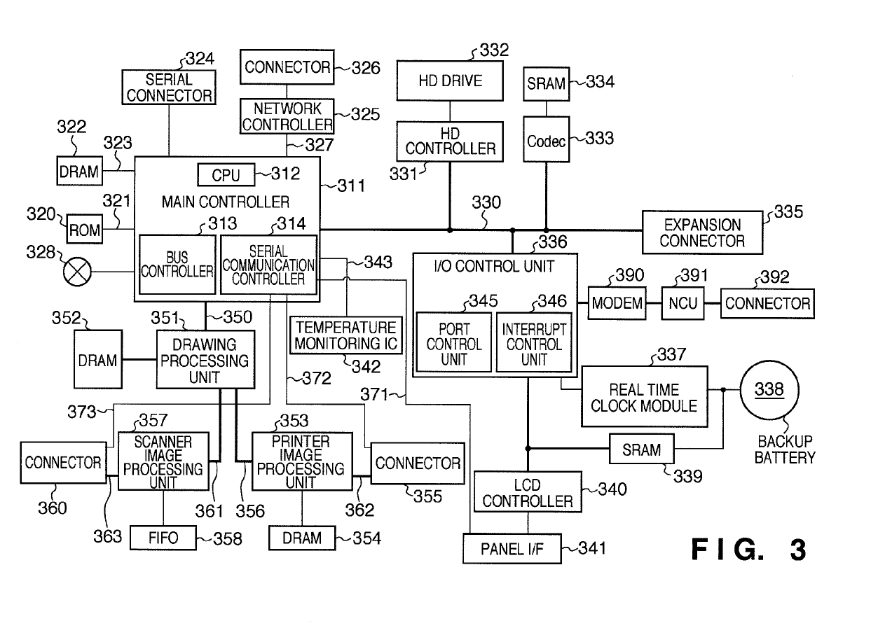

FIG. 3 is a block diagram showing the functional configuration of the control unit 110 of the image forming apparatus according to this embodiment.

A main controller 311 mainly includes a CPU 312, a bus controller 313, and various I/F controller circuits. The CPU 312 and bus controller 313 control the whole control unit 110. The CPU 312 operates based on a program loaded in a DRAM 322 from a HD drive 332 via a HD controller 331. A ROM 320 stores a boot program and the boot program is read out via a ROM I/F 321 upon power on sequence to load the program into the DRAM 323 from the HDD 332. The process of interpreting PDL (Page Description Language) data received form the PC 171 or 172 across the network and rasterizing the data into image data is also executed by processing based on the program. The bus controller 313 controls the transfer of data input and output through each I/F, thereby performing bus arbitration and controlling DMA data transfer. A DRAM 322 is connected to the main controller 311 by a DRAM I/F 323, and used as a work area for the operation of the CPU 312 and an area for storing image data. An asynchronous serial communication controller 314 exchanges control commands with CPUs of the reader unit 120 and printer unit 130 via serial buses 372 and 373. The asynchronous serial communication controller 314 also communicates information of operations performed on the console unit 150 by the user, and information to be displayed on the display unit of the console unit 150.

A network controller 325 is connected to the main controller 311 via an I/F 327, and connected to the network 170 by a connector 326. A general example of the network is the Ethernet. A serial connector 324 is connected to the main controller 311 and communicates with an external apparatus (not shown). A general example of the serial bus is USB. A fan 328 is connected to the main controller 311 and used to cool the control unit 110. A temperature monitor IC 342 is connected to the main controller 311 by a serial bus 343, and used to, for example, control the fan 328, and correct the temperature of a real time clock module 337.

A versatile high-speed bus 330 is connected to an extension connector 335 for connecting an extension board, an I/O control unit 336, the HD controller 331, and a codec (coder/decoder) 333. A general example of the versatile high-speed bus is a PCI bus. The codec 333 compresses raster image data stored in the DRAM 322 by, for example, MH/MR/MMR/JBIG/JPEG, and decompresses the compressed stored code data into raster image data. An SRAM 334 is used as a temporal work area of the codec 333. Data transfer between the SRAM 334 and DRAM 322 is performed by DMA transfer under the control of the bus controller 313. The HD controller 331 is used to connect an external memory. In this embodiment, the hard disk drive (HDD) 332 is connected via this interface. The HDD 332 is used to store programs and image data.

The I/O control unit 336 performs data communication with an LCD controller 340 and modem 390, and includes a port control unit 345 and interrupt control unit 346. A panel I/F 341 is connected to the LCD controller 340, and includes an I/F for displaying image data on the liquid crystal screen of the console unit 150, and a key input I/F 371 for inputting data by hard keys and touch panel keys. The console unit 150 includes a liquid crystal display unit, a touch panel input unit adhered on the liquid crystal display unit, and a plurality of hard keys. A signal input by the touch panel or hard keys is transmitted to the CPU 312 via the above-described panel I/F 341. The liquid crystal display unit displays image data transmitted from the panel I/F 341. This liquid crystal display unit displays, for example, image data and the functions of the operation of this image forming apparatus.

The real time clock module 337 is referred to when updating and saving the date and time managed by the image forming apparatus 100, and backed up by a backup battery 338. An SRAM 339 is also backed up by the backup battery 338, and stores, for example, user modes, various kinds of setting information, and file management information of the hard disk drive 332 in a nonvolatile manner.

A drawing processing unit 351 performs image rotation, image scaling, color space conversion, binarization, scanner image input, and printer image output on image data stored in the DRAM 322. A DRAM 352 is used as a temporal work area of the drawing processing unit 351. The drawing processing unit 351 is connected to the main controller 311 via an I/F 350, and data transfer between the drawing processing unit 351 and DRAM 322 is performed by DMA transfer under the control of the bus controller 313. Connectors 360 and 355 are respectively connected to the reader unit 120 and printer unit 130, and connected to asynchronous serial I/Fs (372 and 373) and video I/Fs (362 and 363).

A scanner image processing unit 357 is connected to the reader unit 120 via the connector 360, and to the drawing processing unit 351 via a scanner bus 361, and has a function of performing predetermined processing on image data received from the reader unit 120. The scanner image processing unit 357 also has a function of outputting, to the scanner bus 361, a control signal generated based on a video control signal transmitted from the reader unit 120. A FIFO 358 is connected to the scanner image processing unit 357, and used to perform line correction on a video signal transmitted from the reader unit 120.

A printer image processing unit 353 is connected to the printer unit 130 via the connector 355, and to the drawing processing unit 351 via a printer bus 356. The printer image processing unit 353 performs predetermined processing on image data output from the drawing processing unit 351, and outputs the image data to the printer unit 130. The printer image processing unit 353 also has a function of outputting, to the printer bus 362, a control signal generated based on a video control signal transmitted from the printer unit 130. The DRAM 354 is connected to the printer image processing unit 353, and used to delay a video signal by a predetermined time.

The bus controller 313 controls the transfer of raster image data rasterized on the DRAM 322 to the printer unit 130. The data is transferred by DMA to the printer unit 130 via the drawing processing unit 351, printer image processing unit 353, and connector 355.

The modem 390 is connected to the IO control unit 336 and an NCU (Network Control Unit) 391. The modem 390 modulates a signal to be transmitted by facsimile to the PSTN (Public Switched Telephone Network) via a connector 392, and demodulates a received signal. When receiving and printing FAX data, input data from the PSTN is demodulated by the NCU 391 and modem 390, and rasterized on the DRAM 322 by the main controller 311 via the I/O control unit 336. Then, under the control of the bus controller 313, the data is transferred by DMA to the printer unit 130 via the drawing processing unit 351, printer image processing unit 353, and connector 355. When scanning and transmitting FAX data, a video signal transmitted from the reader unit 120 is transferred to the main controller 311 via the connector 360, scanner image processing unit 357, and drawing processing unit 351. The modulated data is transmitted from the I/O control unit 336 to the PSTN via the modem 390 and NCU 391.

A copying process as the most basic function of the image forming apparatus 100 according to this embodiment will be described below.

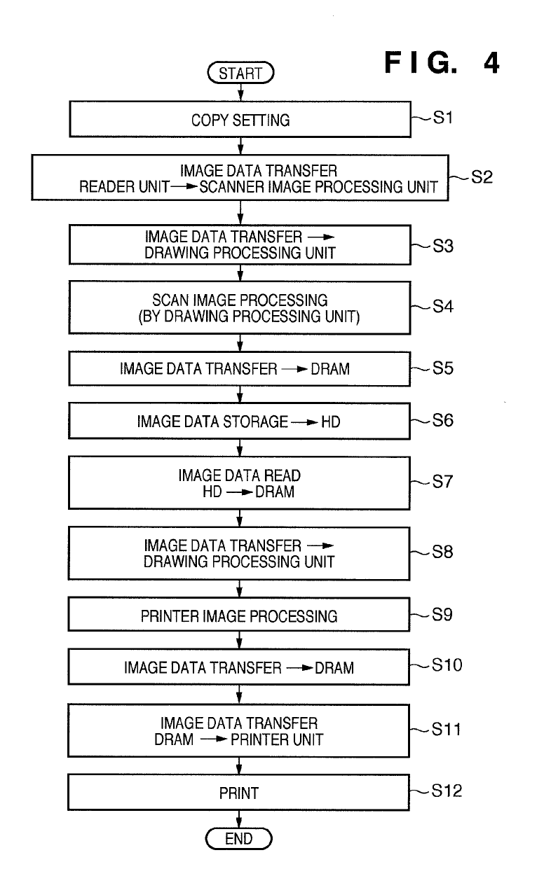

FIG. 4 is a flowchart describing the procedure of copying performed by the image forming apparatus according to this embodiment. The CPU 312 of the main controller 311 achieves this process by executing the program stored in the DRAM 322.

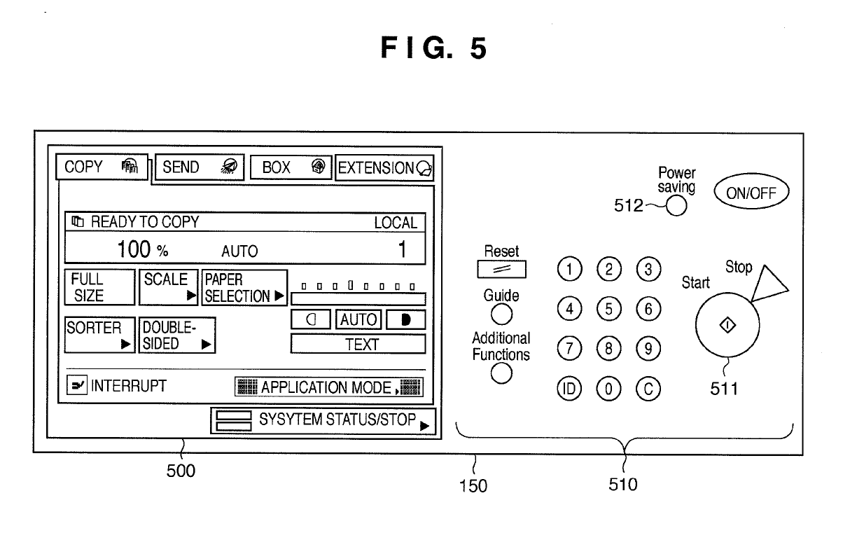

This process is started when a copy instruction is input by a user using the console unit 150. First, in step S1, the copy setting of a copy job entered by the user is input. The contents of the copy setting include the number of copies, the sheet size, single/double-sided printing, the enlargement/reduction ratio, sort output, and with or without stapling. Note that details of the console unit 150 will be described later with reference to FIG. 5. When the user enters a copy start instruction using the console unit 150, the process advances to step S2, and the main controller 311 of the control unit 110 controls the reader unit 120 to read an image of an original. In this case, the original document feed unit 121 feeds originals stacked in the original document feed unit 121 one by one onto the platen glass 211, and simultaneously detects the size of the original. Image data of the original is obtained by exposing and scanning the original based on the detected original size. The image data thus obtained is supplied to the drawing processing unit 351 via the scanner image processing unit 357. The drawing processing unit 351 compresses the image data in the designated image format, and stores the compressed data in the DRAM 322. In this embodiment, an original is always read by full size (100%) regardless of the setting of the enlargement/reduction ratio of the copy setting, and the drawing processing unit 351 performs scaling processing in both the main and sub scan directions. Subsequently, the process advances to step S3, and the scanner image processing unit 357 transfers the image data having undergone signal processing such as a jointing process and masking to the drawing processing unit 351. The process then advances to step S4, and the drawing processing unit 351 performs image processing based on the contents of the copy setting. For example, when an enlargement of 400% is set, the drawing processing unit 351 uses an image scaling unit as a module of the drawing processing unit 351 to perform scaling processing on image data in both the main and sub scan directions. When the image processing of the image data is thus complete, the process advances to step S5. In step S5, the drawing processing unit 351 compresses the processed image data in the designated image format, and transfers the compressed data to the main controller 311. The main controller 311 stores the transferred image data in the DRAM 322. In step S6, the main controller 311 files the image data stored in the DRAM 322 in the designated file format, and stores the file in the HDD 332 via the HD controller 331. These operations are repeated as long as originals exist in the original document feed unit 121.

The image data thus stored in the HDD 332 further undergoes image processing for printing, and the processed data is transferred to the printer unit 130. First, in step S7, if no image file to be printed exists on the DRAM 322, the image file is loaded into the DRAM 322 from the HDD 332. Then, in step S8, the main controller 311 transfers the image data stored in the DRAM 322 to the drawing processing unit 351, and transfers the image data output from the drawing processing unit 351 to the printer image processing unit 353. Subsequently, the process advances to step S9, and the printer image processing unit 353 processes the transferred image data. The process then advances to step S10 to store the processed image data in the DRAM 354. In step S11, while controlling the printer unit 130 via the connector 355, the main controller 311 transfers the processed image data stored in the DRAM 354 to the printer unit 130 at an appropriate timing. In step S12, the control unit 110 controls the printer unit 130 to print the image data. When the originals stacked in the original document feed unit 121 are copied by the number of copies designated by the copy setting, this process is terminated.

FIG. 5 depicts an external view illustrating an example of the console unit 150 of the image forming apparatus according to this embodiment.

The console unit 150 is separated into a UI display section 500 and hard-key operation section 510. The user can set various copy modes (for example, double-sided printing, grouping, sorting, and stapling) by using the console unit 150. Note that these copy modes can be set by using the hard-key operation section 510 including hard keys, or by using soft keys displayed on the touch panel of the UI display section 500. A start button 511 is used to designate the start of a copying process or transmitting process. A key 512 is used to designate the setting of a power saving mode.

The scanner image processing unit 357 will be explained in detail below.

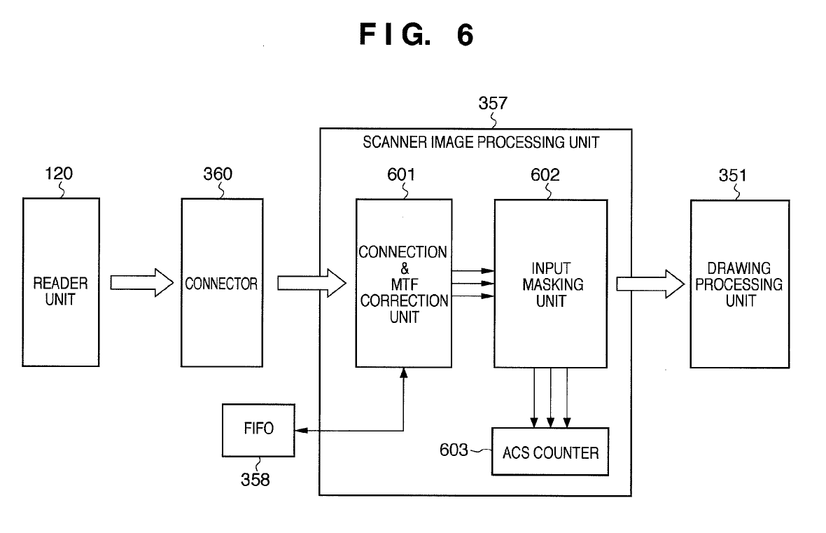

FIG. 6 is a block diagram describing the arrangement of the scanner image processing unit 357 according to this embodiment. Note that in FIG. 6, the same reference numerals as in FIGS. 1 and 3 described previously denote the same parts, and a repetitive explanation will be omitted.

With respect to image data supplied from the reader unit 120 via the connector 360, a joint & MTF (Modulation Transfer Function) correction unit 601 adjusts the delay amount of each line in accordance with the read rate, thereby correcting the MTF having changed in accordance with the read rate. When the CCD 218 (FIG. 2) is a three-line CCD, a jointing process corrects signal timings such that the read positions of the three lines are the same. The FIFO 358 is used as a buffer for delaying one-line image data. Based on the image data corrected to have the same read position by the joint & MTF correction unit 601, an input masking unit 602 corrects the spectral characteristics of the CCD 218, lamp 212, and mirrors 214, 215, and 216. The output from the input masking unit 602 is supplied to an ACS counter 603 for performing automatic color selection and the drawing processing unit 351.

The printer image processing unit 353 will now be explained.

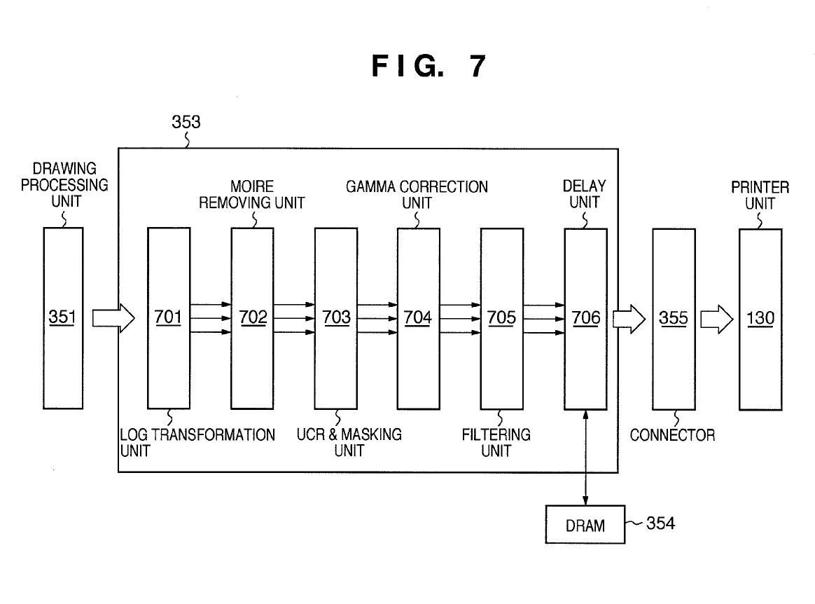

FIG. 7 is a block diagram describing the arrangement of the printer image processing unit 353 according to this embodiment. Note that in FIG. 6, the same reference numerals as in FIGS. 1 and 3 described previously denote the same parts, and a repetitive explanation will be omitted.

Image data supplied from the drawing processing unit 351 via the printer bus 356 is first input to a LOG transformation unit 701. The LOG transformation unit 701 converts RGB into CMY by LOG transformation. Then, a moire removing unit 702 removes moire. A UCR & masking unit 703 performs UCR processing on the CMY image data having undergone the moire removing process, thereby generating CMYK image data. A masking unit corrects this CMYK image data into image data suitable for the printer unit 130. A gamma correction unit 704 adjusts the density of the image data processed by the UCR & masking unit 703. After that, a filtering unit 705 performs a smoothing or edging process on the image data. A delay unit 706 stores the CMYK image data in the DRAM 354, delays the CMYK image data in order to correct the output timing of the image data of each color, and outputs the image data to the printer unit 130 via the connector 355.

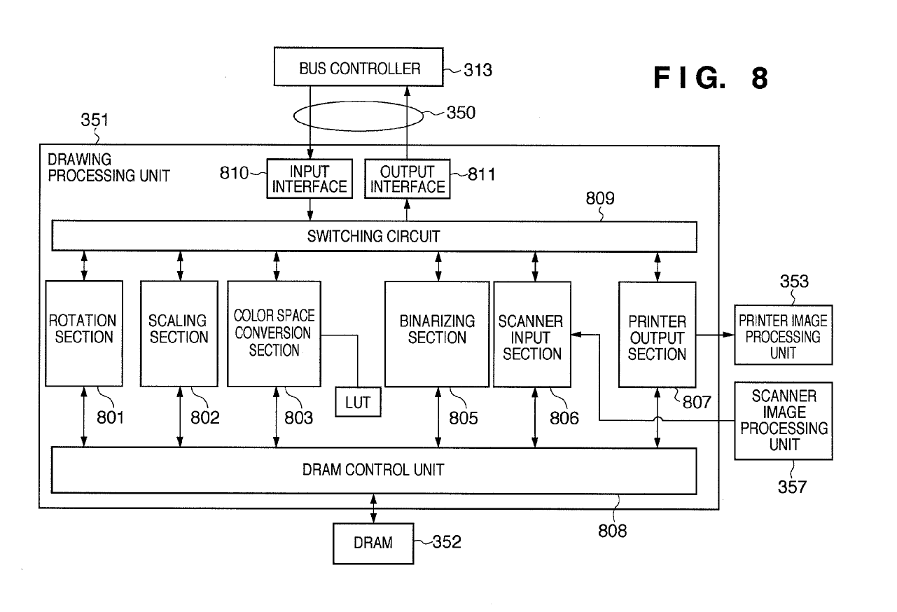

FIG. 8 is a block diagram describing the arrangement of the drawing processing unit 351 according to this embodiment.

The drawing processing unit 351 includes a rotation section 801, scaling section 802, color space conversion section 803, binarizing section 805, scanner input section 806, and printer output section 807 as modules. The DRAM 352 is used as a temporal work area of each module via a DRAM control unit 808. Work areas of the DRAM 352 are statically allocated to the individual modules in advance so that these work areas of the modules do not overlap each other. The drawing processing unit 351 is connected to the main controller 311 via the I/F 350, and data transfer between the drawing processing unit 351 and DRAM 322 is performed by DMA transfer under the control of the bus controller 313. The bus controller 313 controls the setting of, for example, a mode in each module of the drawing processing unit 351, and controls the timing at which image data is transferred to each module. An input interface 810 inputs image data input from the I/F 350 to a switching circuit 809. The format of this image data is, for example, binary raster image data, multilevel raster image data, or JPEG compression. When the image data is a JPEG image, the input interface 810 converts the JPEG image data into raster image data, and inputs the converted image data to the switching circuit 809. An output interface 811 outputs the input image data from the switching circuit 809 to the I/F 350. Although the format of this image data is raster image data, the output interface 811 may also perform JPEG compression on the image data, and then output the compressed image data to the I/F 350.

The image forming apparatus according to this embodiment can set the print density while executing a printing operation.

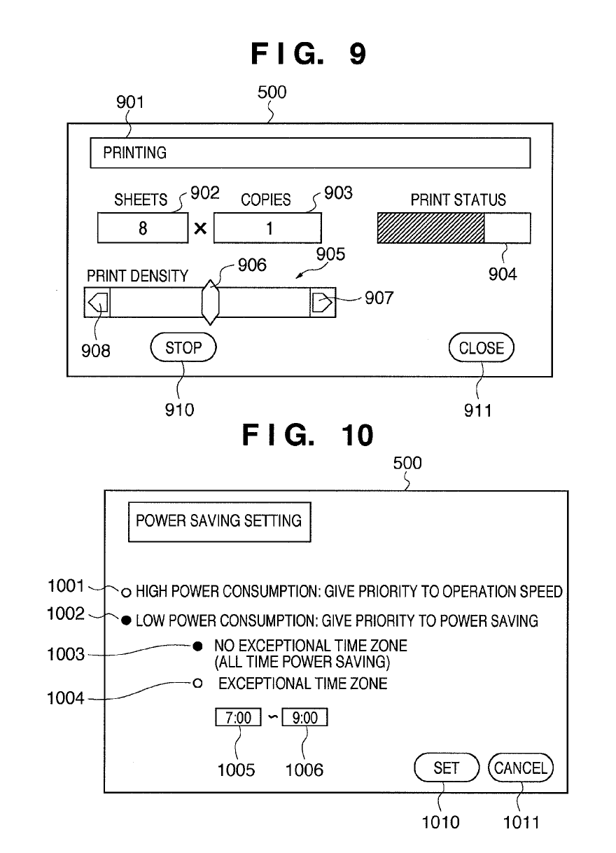

FIG. 9 is a view illustrating an example of a window displayed on the UI display section 500 of the console unit 150 while the image forming apparatus 100 according to this embodiment is performing printing.

When printing is started, a sub window shown in FIG. 9 is popped up on the UI display section 500 of the console unit 150. This sub window displays, in a title display 901, a message “PRINTING” indicating that printing is currently being executed. A count display section 902 displays the count per copy. A copies display section 903 displays the number of copies to be printed. A print status display section 904 displays the progress of the printing process in the form of a progress bar. A print density adjust section 905 is a slider for adjusting the print density. The print density adjust section 905 increases the density when a button 907 is touched, and decreases the density when a button 908 is touched. A cursor button 906 horizontally moves in accordance with whether the button 907 or 908 is touched, thereby allowing the user to confirm the set density state. Thus, the user can change the print density by operating the buttons of the print density adjust section 905 even during a printing operation. The CPU 312 accepts the change of the print density, and performs control to set a parameter corresponding to the accepted print density in registers for image processing, between a plurality of conveyed sheets. An abort button 910 is used to abort the printing process. This sub window is closed when the user touches a close button 911.

Note that the density value adjusted by the print density adjust section 905 during printing is stored in the DRAM 322 of the control unit 110. The density value adjusted by the print density adjust section 905 is stored in the volatile DRAM 322 because this density value is merely a density change during printing and need not be saved after the electric power supply of the image forming apparatus 100 is turned off.

FIG. 10 is a view illustrating an example of a window displayed on the UI display section 500 when performing power saving setting in the image forming apparatus according to this embodiment.

The UI display section 500 displays this electric power saving setting window when a power saving mode key 521 of the console unit 150 is pressed. This power saving setting window includes radio buttons 1001 and 1002 for setting the power saving level; the radio button 1001 selects “high power consumption” (a normal mode), and the radio button 1002 selects “low power consumption”. When the radio button 1002 is selected (low power consumption), the user can select the presence/absence of exceptional time zone designation for designating a time zone during which the mode for suppressing the power consumption is canceled, by using radio buttons 1003 and 1004. The radio button 1003 is a button for designating no exceptional time zone designation. When the radio button 1003 is selected, a mode in which a power saving priority operation is always performed is set. The radio button 1004 is a button for designating a time zone during which no power saving priority mode is set. By selecting the radio button 1004, the user can designate the time zone by start time 1005 and end time 1006. When “low power consumption” is set in the image forming apparatus 100 of this embodiment, the control unit 110 (main controller 311) performs control so as to suppress the electric power to be supplied to the heater of the fixing unit 277, in order to reduce the power consumption. Also, the control unit 110 controls the paper feed unit (one of the cassettes 261 to 264 or the manual feed tray 265) to feed sheets at a short sheet interval. By thus feeding sheets by decreasing the sheet interval, images can be fixed while the amount of heat generated by the fixing unit 277 between sheets is suppressed. This makes it possible to reduce power required for reheating. Accordingly, it is possible to shorten the total heating time of the fixing unit 277 shown in FIG. 2, and reduce the accumulated power consumption from the start to the end of printing.

In addition, the control unit 110 of this embodiment partially omits the setting of a density register in order to decrease the sheet interval as described above. This is so because the density register has an LUT (Look-Up Table), and the size of the LUT is as large as 4.7 MB, so the density register cannot be set in time at a short sheet interval if the setting is unconditionally entirely performed. In this embodiment, the sheet interval can be shortened because the control unit 110 partially omits the setting of the density register. Thus, the control unit 110 can convey fed sheets at a first interval or a second interval shorter than the first interval.

A set button 1010 is used to give an instruction to update the power saving setting by set values set in this window. The set values are stored in the SRAM 339 backed up by the battery 338 in the control unit 110. Accordingly, these set values are held in a nonvolatile manner. Also, when a cancel button 1011 is touched, these set values in this window are canceled, and the power saving setting window is closed.

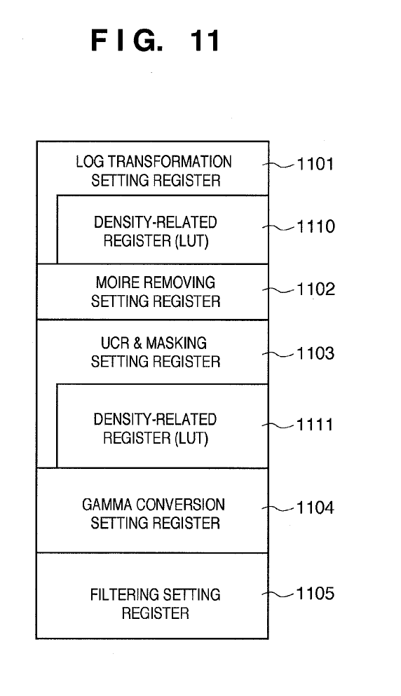

FIG. 11 depicts a view illustrating an example of a register map of registers for holding setting information to be set in the image processing units (701 to 705) of the printer image processing unit 353 according to this embodiment. These pieces of setting information are stored in the SRAM 339 (FIG. 3) backed up by the battery 338.

The registers shown in FIG. 11 include a LOG conversion setting register 1101, moire reduction setting register 1102, UCR & masking setting register 1103, gamma conversion setting register 1104, and filtering setting register 1105. The LOG transformation setting register 1101 includes a density-related register (LUT) 1110 related to the density. Likewise, the UCR & masking setting register 1103 includes a density-related register 1111 (LUT). The set values of the density-related registers 1110 and 1111 are set or changed in a time period from the end of printing of the current sheet to the start of printing of the succeeding sheet. Therefore, when performing image processing for printing the succeeding sheet, the printer image processing unit 353 performs the image processing in accordance with the set or changed density. That is, the density of image data to be processed by the printer image processing unit 353 is determined by setting a density-related parameter in the density-related registers 1110 and 1111. The image data thus processed is output to the printer unit 130 via the connector 355 shown in FIG. 7, and printed.

The process of controlling whether to set a parameter in the above-described registers in accordance with whether the power saving priority mode is set will be explained below with reference to a flowchart shown in FIG. 12.

FIG. 12 is a flowchart describing the process of setting various data in the registers (FIG. 11) of the printer image processing unit 353 in the image forming apparatus according to this embodiment. Note that this process is executed under the control of the CPU 312 in accordance with the program stored in the DRAM 322 of the main controller 311.

First, in step S21, a set value stored in the SRAM 339 and indicating whether power saving priority is set is loaded. Then, the process advances to step S22 to determine whether or not power saving priority (low power consumption) is set. Note that this power saving priority can be set by pressing the power saving key 512 of the console unit 150 shown in FIG. 5. If no power saving priority is set, it is determined to set respective corresponding data in the registers (FIG. 11) of the printer image processing unit 353. Accordingly, the process advances to step S23 to load the density value stored in the DRAM 322, then advances to step S24 to set the density value loaded in step S23 in the density-related registers 1110 and 1111 among the registers of the printer image processing unit 353. After that, the process advances to step S25 to set unset registers among the registers (1101, 1102, 1103, 1104, and 1105) shown in FIG. 11, thereby terminating the register setting. The procedure of the process advancing through steps S23, S24, and S25 indicates the procedure of the process of setting all the registers.

On the other hand, if it is determined in step S22 that power saving priority (low power consumption) is set, the process advances to step S26 to load the present time from the real-time clock module 337. Then, the process advances to step S27 to determine whether the present time loaded in step S26 corresponds to the power saving exceptional time zone (the time zone during which no power saving mode is set). If it is determined that the present time corresponds to the power saving exceptional time zone, the process advances to the density setting information loading process in step S23, in the same manner as when no power saving priority is set. This power saving exceptional time zone is set by the start time 1005 and end time 1006 when the radio button 1004 shown in FIG. 10 is selected.

On the other hand, if it is determined in step S27 that the present times does not correspond to the power saving exceptional time zone (the power saving operation is being executed), the process advances to step S28 to determine whether to print a plurality of copies. If it is unnecessary to print a plurality of copies (if it is necessary to print only one copy), the process advances to step S25 to set unset registers among the registers 1101, 1102, 1103, 1104, and 1105 except for the density-related registers.

If it is determined to print a plurality of copies in step S28, the process advances to step S29 to determine whether the next printing data is data to be printed on the first sheet of the respective copies. If it is determined that the next printing data is data to be printed on the first sheet of each copy, the process advances to the density setting information loading process in step S23, in the same manner as when no power saving priority is set.

On the other hand, if the next printing data is not data to be printed on the first sheet of the copy, the process advances to step S25 to set unset registers among the registers 1101, 1102, 1103, 1104, and 1105 except for the density-related registers 1110 and 1111.

As described above, when only one copy is to be printed in the power saving priority mode or when a plurality of copies are to be printed and the data is to be printed on a sheet except for the first sheet in the power saving priority mode, it is possible to omit setting process of the density-related parameters performed between a sheet currently being printed and a succeeding sheet to be printed next. Since this can shorten the processing time between sheets, it is possible to effectively shorten the total time required for printing, and reduce the power consumption required for the whole printing.

Also, even in the power saving priority mode, when printing a plurality of copies, the changed density parameters can be set in the registers before the first sheet of each copy is printed. Accordingly, an image having undergone image processing corresponding to the latest density setting can be printed for at least each copy.

The process of omitting setting process of the density parameters when printing only one copy will additionally be explained by noting the corresponding portion of the flowchart shown in FIG. 12.

In step S28, it is determined whether to print a plurality of copies. Whether to print a plurality of copies or only one copy is determined by referring to the number of copies displayed in the copies display section 903 (FIG. 9) displayed on the UI display section 500 of the console unit 150. The number of copies is input from the hard-key operation section 510 of the console unit 150 before the start of copying, and stored in the DRAM 322. Therefore, whether to print only one copy or a plurality of copies is determined by reading the number of copies to be printed stored in the DRAM 322. If it is determined in step S28 to print only one copy, the process advances to step S25 to set unset registers among the registers 1101, 1102, 1103, 1104, and 1105. In this way, when a density changing operation is performed while only one copy is being printed and power saving is given priority, the sheet interval between a sheet currently being printed and a sheet to be printed next can be shortened by omitting setting process of the density-related parameters between sheets to the registers.

Accordingly, the fixing device for fixing printed sheets can successively fix sheets at a short sheet interval. This makes it possible to shorten the total heating time of the fixing unit 277 shown in FIG. 2, and reduce the accumulated power consumption from the start to the end of printing.

The procedure of omitting setting process of the density parameters when printing a plurality of copies will additionally be explained by noting the corresponding portion of the flowchart shown in FIG. 12.

If it is determined in step S28 of FIG. 12 that a plurality of copies are to be printed, the process advances to step S29 to determine whether printing data to be printed next is data to be printed on the first sheet of a copy. If it is determined that the printing data is for the first sheet of a copy, the process advances to the density setting information loading process in step S23. On the other hand, if it is determined that the printing data is not for the first sheet of a copy, the process advances to step S25 to set unset registers among the registers 1101, 1102, 1103, 1104, and 1105.

Thus, when printing a plurality of copies, the change in density is reflected when printing the first printing data for the first sheet in a copy, and the density is not changed during the printing process of the copy until the final sheet of the copy, even if the user performs a density adjusting operation during printing of the copy. While a copy is being printed, therefore, printing can be performed by decreasing the interval between a sheet currently being printed and a succeeding sheet to be printed next. It is also possible to shorten the time required for fixing because fixing is performed by decreasing the interval between successive sheets.

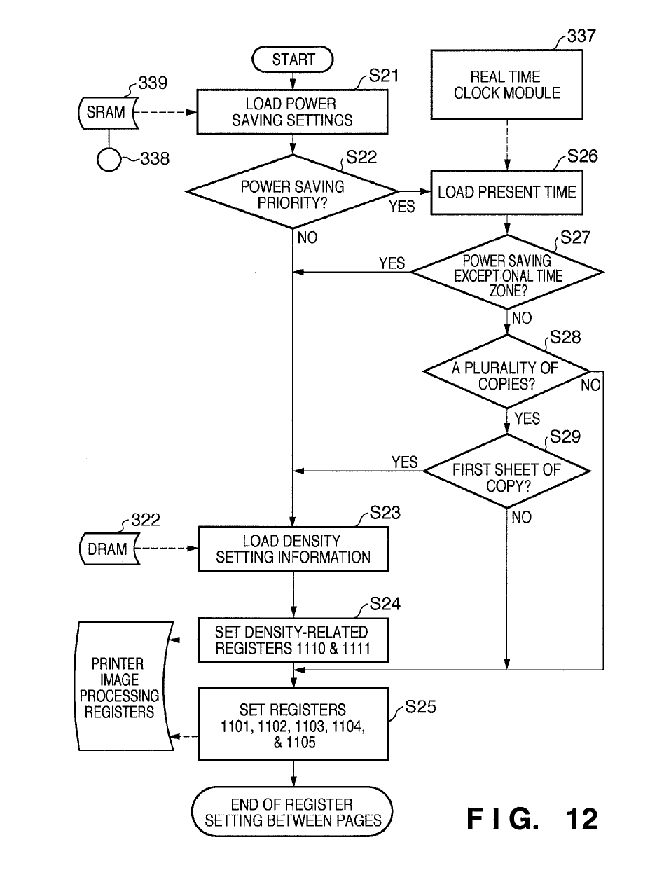

The embodiment of omitting setting process of the density-related parameters during printing in accordance with the power saving setting has been explained above. Next, the way the sheet interval shortens and the power saving effect occurs in practice when the setting process of the density-related parameters is omitted and is not omitted will be explained below with reference to timing charts shown in FIGS. 13 to 15.

FIG. 13 is a timing chart when setting data in all the registers of the printer image processing unit 353 between sheets in accordance with a user's density adjusting operation in the image forming apparatus 100 according to this embodiment.

First, an operation when the power saving setting is set to “high power consumption (no power consumption priority)” and a changed density set value is reflected during printing (image formation) will be explained with reference to FIG. 13.

In FIG. 13, reference numeral 1310 denotes the occurrence timing of an event in which the user performs a density changing operation by using the console unit 150, numeral 1320 denotes the setting timing between sheets, numeral 1330 denotes the output timing of printing data; and numeral 1340 denotes the conveyance/printing timing of each sheet.

Before the first sheet is printed, all the registers of the printer image processing unit 353 are set in 1321, and the result of image processing performed in accordance with this setting is output as printing data of the first sheet at a timing 1331. In synchronism with the timing 1331 of the data of the first sheet, a sheet on which the printing data of the first sheet is to be printed is conveyed and printed in 1341.

Reference numerals 1311 and 1312 each denote the timing of an event in which the print density is changed during the printing operation. In this timing chart, the density changing event 1311 occurs during the printing of the first sheet, and this density change is reflected on all the registers of the printer image processing unit 353 at a timing 1322 before an image is formed on the second sheet. Image data to be printed on the second sheet is processed in accordance with the reflected density changing parameters, and output as printing data of the second sheet in 1332. In 1342, the second sheet is conveyed, and a printing process is performed on the second sheet. In page presetting 1323 before the third sheet, no density change occurs from the console unit 150, so processing is performed based on the full register setting set for the second sheet. Image processing is thus performed in the same manner as for the second sheet to output printing data to be printed on the third sheet in 1333, and the third sheet is conveyed and printed in 1343.

If the density changing event 1312 occurs while the third sheet is being printed, this density change is reflected in 1324 by setting the change in all the registers of the printer image processing unit 353. As shown in the timing chart as described above, a sheet conveyance interval T1 (equivalent to the sheet interval) prolongs because all the registers of the printer image processing unit 353 are set between sheets. In FIG. 13 as described above, data is set in all the registers of the printer image processing unit 353 immediately before the printing of each sheet is started. Accordingly, the sheet conveyance intervals T1 are the same.

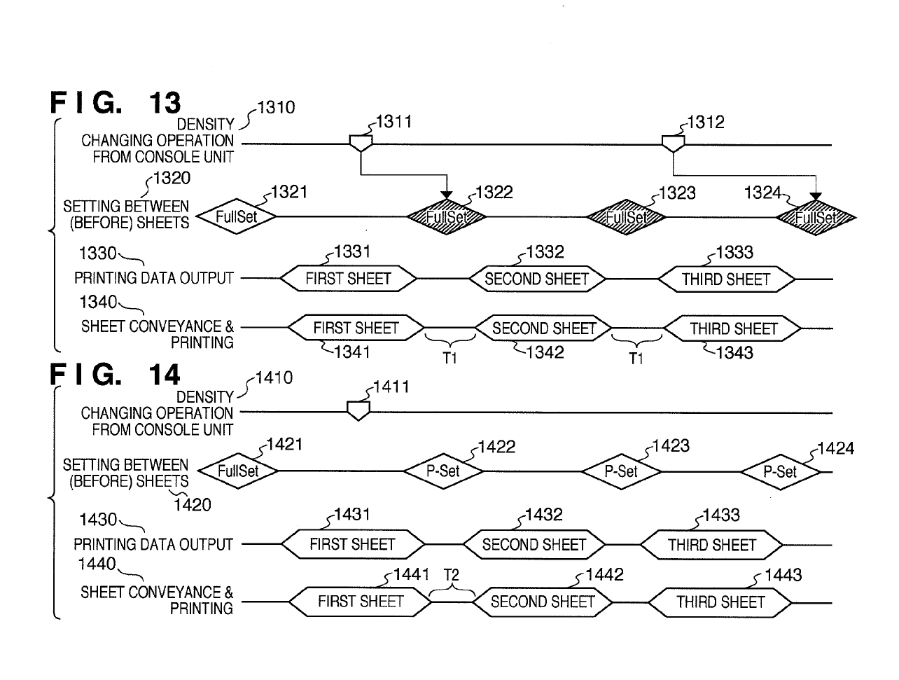

For comparison, an operation of omitting the setting of the density-related parameters in the registers when the power saving setting is set to “low power consumption (power saving priority)” will be explained below with reference to the timing chart shown in FIG. 14.

FIG. 14 is a timing chart when the density change setting of the printer image processing unit 353 is omitted when printing only one copy.

In FIG. 14, reference numeral 1410 denotes the occurrence timing of an event in which the user performs a density changing operation by using the console unit 150, numeral 1420 denotes the register setting timing, numeral 1430 denotes the output timing of printing data to be printed on each sheet, and numeral 1440 denotes the conveyance/printing timing of each sheet.

In the same manner as described above, before the first sheet is printed, all the registers of the printer image processing unit 353 are set in 1421, and the result of image processing performed in accordance with this setting is output as printing data to be printed on the first sheet at a timing 1431. In synchronism with the timing 1431, a sheet on which the printing data of the first sheet is to be printed is conveyed and printed in 1441.

A marker 1411 indicates the occurrence timing of an event in which the print density is changed from the console unit 150 while the first sheet is being printed. In this timing chart, the density change occurs during the printing of the first sheet, but the setting process of the density-related parameters designated in 1411 is omitted in 1422 (the processes in steps S23 and S24 of FIG. 12 are skipped). In 1432 in which printing data of the second sheet is output, therefore, the setting process to the registers is omitted, and the density change is executed in accordance with the same density-related parameters as that for the first sheet. In 1442, a sheet on which the printing data of the second sheet is to be printed is conveyed, and the printing data of the second sheet is printed on the sheet.

Similarly, the setting process of the density-related parameters changed by the user in 1411 for the first sheet is omitted at timings 1423 and 1424. Accordingly, printing data of the third sheet to be output in 1433 and printed in a sheet conveyance/printing process of 1443 is also printed by neglecting the density change in 1411.

Consequently, an interval T2 (equivalent to the sheet interval) at which sheets to be printed are conveyed becomes shorter than T1 shown in FIG. 13 (T1>T2) because the setting process of the density-related parameters is omitted between the present sheet and succeeding sheet and this shortens the sheet conveyance interval.

That is, printing is performed by decreasing the interval (sheet interval) between sheets by a time of (T1−T2). When printing, for example, 10 sheets, therefore, the printing time can be made shorter by a time equivalent to {(T1−T2)×10} than that when all the registers are set for every sheet as shown in FIG. 13. Since this makes it possible to shorten the total heating time of the fixing unit 277 by the time equivalent to {(T1−T2)×10}, the accumulated power consumption from the start to the end of printing can be reduced.

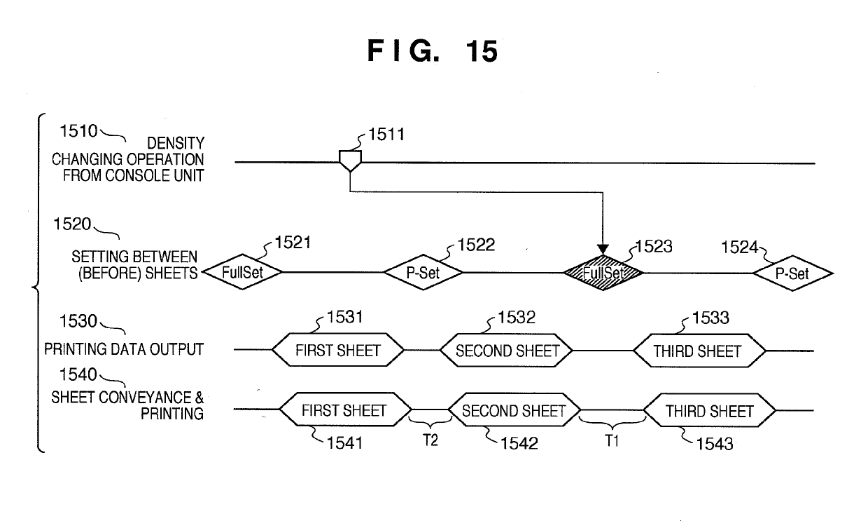

An operation of omitting the setting of the density-related parameters when printing sheets of a plurality of copies will be explained below with reference to the timing chart shown in FIG. 15.

FIG. 15 is a timing chart when the setting process of the density changed parameters of the printer image processing unit 353 is omitted when printing sheets of a plurality of copies.

In FIG. 15, reference numeral 1510 denotes the occurrence timing of an event in which the user performs a density changing operation from the console unit 150, numeral 1511 denotes the timing of parameter setting between sheets, numeral 1530 denotes the output timing of printing data, and numeral 1540 denotes the conveyance/printing timing of each sheet.

In the same manner as described previously, before the first sheet is printed, all the registers of the printer image processing unit 353 are set in 1521, and the result of image processing performed in accordance with this setting is output as printing data of the first sheet at a timing 1531. In synchronism with this data output, the first sheet is conveyed and printed in 1541.

Reference numeral 1511 indicates the occurrence timing of an event in which the print density is changed by a user's operation while the first sheet is being printed. In this timing chart, the density change occurs during the printing of the first sheet, but the setting process of the density-related parameters is omitted in the setting of the registers of the printer image processing unit 353 in 1522. Therefore, the density change performed in 1511 is not reflected in 1532 at which printing data of the second sheet is output. In 1542, the second sheet is conveyed, and the printing data of the second sheet is printed on the sheet.

FIG. 15 is a timing chart when one copy includes two sheets. Accordingly, at inter-sheet setting 1523 before the first sheet of the next copy is printed, a break occurs between the copies, so all the registers of the printer image processing unit 353 are set in accordance with the density change performed in 1511. Consequently, the density setting changed in 1511 is reflected herein. A printing process is performed on a sheet of the second copy by reflecting the density change, by outputting printing data of the first sheet of the second copy in 1533, and conveying and printing the first sheet of the second copy in 1543.

Subsequently, in register setting in 1524, the second sheet of the second copy is printed, so the processing is performed by omitting the setting process of the density-related parameters.

As has been explained above, the sheet conveyance interval is T1 only when a break occurs between copies (before the first sheet of each copy), and is T2 (T1>T2) between sheets in other cases. Similar to FIG. 14, therefore, a printing process is performed by decreasing the sheet interval by a time of (T1−T2) between sheets of the same copy. Accordingly, when each copy includes, for example, 10 sheets, the printing time can be shortened by a time equivalent to {(T1−T2)×10} per copy, compared to the operation in which all the registers are set whenever each sheet is printed.

In addition, the total heating time of the fixing unit 277 can be shortened in proportion to the time equivalent to {(T1−T2)×10}. This makes it possible to reduce the accumulated power consumption from the start to the end of printing.

Also, when printing sheets of a plurality of copies, all the registers are set only between copies (before the first sheet of each copy is printed). Therefore, images printed on sheets of the same copy have the same density, and images are printed on sheets of the next copy by the density corresponding to the changed density-related parameter.

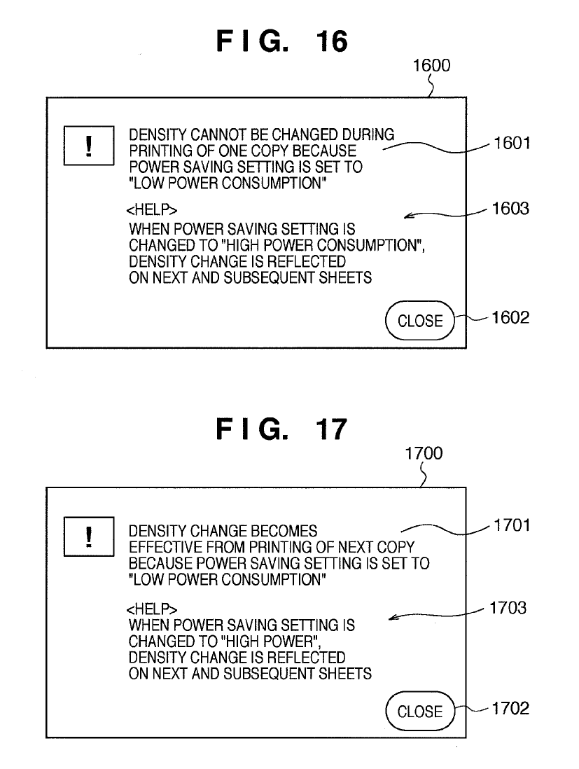

FIG. 16 depicts a view illustrating an example of a window displayed on the UI display section 500 when the user performs a density changing operation during printing.

When the print density adjusting section 905 shown in FIG. 9 changes the print density during printing, a sub window 1600 indicating the impossibility of density change is popped up on the UI display section 500 of the console unit 150. In the sub window 1600, a message display 1601 displays a message indicating that the density cannot be changed while a printing process in which the number of copies is one is being executed. In addition, a help message is displayed as 1603. The sub window 1600 is closed when the user touches a close button 1602. The help message 1603 displays that when the power saving setting is set to “high power consumption”, the print density adjusting section 905 can change, even during printing, the density of an image to be printed on the succeeding sheet.

As described above, when “low power consumption” is set in the power saving priority mode and the user performs an operation of changing the density during the printing of one copy, display control is performed to display the message indicating the impossibility of density change shown in FIG. 16. This makes it possible to present the user performing a copying operation in the power saving mode with the information indicating that the copy density cannot be changed in the middle of the copy presently being printed, and with the method of avoiding (coping with) the problem.

When power saving priority is set and the user performs a density changing operation from the console unit 150 while printing is being performed on sheets of a plurality of copies, this density change is delayed before being executed. This operation will be explained below.

FIG. 17 depicts a view illustrating an example of a window displayed on the UI display section when the user performs a density changing operation during a printing operation.

When the print density adjusting section 905 changes the print density during printing, a sub window 1700 displaying the delay of density change is popped up on the UI display section 500 of the console unit 150. A message 1701 in the sub window 1700 displays information indicating that the density change performed during the printing of a copy of a plurality of copies is reflected on the printing of the succeeding copy. In addition, a help message is displayed as indicated by 1703. The sub window 1700 is closed when the user touches a close button 1702. The help message 1703 displays that when the power saving setting is set to “high power consumption”, the density change performed by the print density adjusting section 905 can be reflected on the printing of the subsequent sheet even during printing.

As described above, when “low power consumption” is set in the power saving priority mode and the user performs a density changing operation while the printing of sheets of a plurality of copies is being designated and executed, the message 1701 indicating the delay of the density change shown in FIG. 17 is displayed. This makes it possible to notify the user performing the copying operation of the information indicating that the density change is reflected on the printing of the subsequent copy, and the method of avoiding the problem.

The power saving exceptional time zone setting section will solely be explained below.

As already explained earlier, FIG. 10 is a view showing an example of the window displayed on the UI display section 500 when performing the power saving setting. When the radio button 1002 of “low power consumption” is selected, whether to designate an exceptional time zone can be selected as detailed setting by the radio buttons 1003 and 1004.

The radio button 1003 is a button for designating no exceptional time zone. When the radio button 1003 is checked, an operation giving priority to power saving is performed in the entire time zone. The radio button 1004 is a button for designating an exceptional time zone. When the radio button 1004 is checked, power saving priority is canceled in a time zone set by the start time 1005 and end time 1006, and the operation is performed with “high power consumption” in this time zone. The user can set each of the start time 1005 and end time 1006 by touching the inside of the frame and entering numerals from the hard-key operation section 510 of the console unit 150.

Thus, a time zone in which power saving priority is canceled can be set. Therefore, in an office in which, for example, a worker performs copying quickly and immediately goes out for business in the morning, a time zone from 8:00 a.m. to 9:00 a.m., for example, is excluded from the power saving time zone. As a consequence, a density changing instruction given by the user can rapidly be reflected on the printing result.

In this embodiment as has been explained above, when setting power saving priority, the setting process of the density-related parameters performed between sheets is omitted. Since this advances the timing of the start of printing of the succeeding sheet, printing can be performed by decreasing the sheet interval when printing a plurality of sheets. Consequently, the total heating time of the fixing unit can be shortened because fixing can be performed by decreasing the sheet interval. Therefore, the accumulated power consumption from the start to the end of printing can be reduced when printing a plurality of sheets.

Also, when printing only one copy in this embodiment, the setting process of the density-related parameters designated by a density adjusting operation during printing is omitted for all sheets in the copy. Accordingly, all the sheets of the copy can be fixed by decreasing the sheet interval.

Furthermore, in this embodiment, even when a density adjusting operation is performed during the printing of one copy, the density adjustment is reflected for the first time on the printing of the succeeding copy. Therefore, printing and fixing can be performed by decreasing the sheet interval during the printing of one copy. Also, even when a density adjusting operation is performed during the printing of one copy, the density adjustment is reflected only between copies. This makes it possible to change the density for sheets of the succeeding copy while holding a uniform density in the same copy.

In this embodiment, when a density changing operation is performed during the printing of one copy, it is possible to present the user performing the operation with information indicating that the density cannot be changed during the printing of the copy, and a method of avoiding the problem.

In this embodiment, when a density changing operation is performed during the printing of a plurality of copies, it is possible to present the user performing the operation with information indicating that the density change is reflected on the subsequent copy, and a method of avoiding (coping with) the problem.

In this embodiment, a time zone in which power saving priority is canceled can be set. Accordingly, a density change or the like of copying can rapidly be reflected in this time zone.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-144643, filed Jun. 17, 2009, which is hereby incorporated by reference herein in its entirety.

What is claimed is:

1. An image forming apparatus comprising:
a setting unit configured to set parameters of image processing to be executed on image data;
an image processing unit configured to process the image data in accordance with the parameters of the image processing set by the setting unit;
a conveyance control unit configured to convey, when conveying a plurality of sheets on each of which an image is to be formed, the plurality of sheets at one of a first interval and a second interval shorter than the first interval;
an image forming unit configured to form an image on a sheet conveyed by the conveyance control unit, based on the image data processed by the image processing unit; and
a control unit configured to (i) control the setting unit to set the parameters, when conveying the plurality of sheets at the first interval by the conveyance control unit and forming an image by the image forming unit, and (ii) control the setting unit not to set a part of the parameters, when conveying the plurality of sheets at the second interval by the conveyance control unit and forming an image by the image forming unit.

2. The apparatus according to claim 1, wherein the setting unit sets the parameters between sheets included in the plurality of sheets.

3. The apparatus according to claim 1, wherein the setting unit sets the parameters based on setting accepted from a user via a console unit, and sets the parameters based on the setting accepted from the user via the console unit even while the image forming unit is executing an image forming operation.

4. The apparatus according to claim 1, further comprising an operation control unit configured to operate the image forming apparatus in one of a normal mode and a power saving mode in which power consumption is lower than that in the normal mode,
wherein the conveyance control unit conveys the plurality of sheets at the first interval in a case that the image forming apparatus is operating in the normal mode, and conveys the plurality of sheets at the second interval in a case that the image forming apparatus is operating in the power saving mode.

5. The apparatus according to claim 1, further comprising a display control unit configured to display, in a case that the setting unit does not the part of the parameters, information indicating that the part of parameters is not set, on a display unit.

6. The apparatus according to claim 1, wherein the parameters of the image processing include an image density value.

7. An image forming apparatus comprising:
an image processing unit configured to process image data in accordance with parameters of image processing;
a setting unit configured to set, in the image processing unit, parameters of image processing input in accordance with a user's operation;
a conveyance control unit configured to control sheet conveyance, when conveying a plurality of sheets on each of which an image is to be formed, in a first mode in which the plurality of sheets are conveyed at a first interval, and a second mode in which the plurality of sheets are conveyed at a second interval shorter than the first interval;
an image forming unit configured to form an image on a sheet conveyed by the conveyance control unit, based on the image data processed by the image processing unit; and
a control unit configured to (i) control the setting unit to set the parameters of the image processing in the image processing unit between sheets, when forming an image on a sheet conveyed in the first mode, and (ii) control the setting unit to set the parameters of the image processing in the image processing unit only in image formation for one of a first sheet of the plurality of sheets and a first sheet of each copy, when forming an image on a sheet conveyed in the second mode.

8. A control method of an image forming apparatus, comprising:
a setting step of setting parameters of image processing to be executed on image data;
an image processing step of processing the image data in accordance with the parameters of the image processing set in the setting step;
a conveyance control step of conveying, when conveying a plurality of sheets on each of which an image is to be formed, the plurality of sheets at one of a first interval and a second interval shorter than the first interval;
an image forming step of forming an image on a sheet conveyed in the conveyance control step, based on the image data processed in the image processing step; and
a control step of controlling the setting step to set the parameters when conveying the plurality of sheets at the first interval in the conveyance control step and forming an image in the image forming step, and
controlling the setting step to set a part of the parameters when conveying the plurality of sheets at the second interval in the conveyance control step and forming an image in the image forming step.

9. A computer-readable storage medium storing a program which causes a computer to execute a control method defined in claim 8.
